(19) United States
(12) Patent Application Publication
(10) Pub. No.: US 2024/0311906 A1
(43) Pub. Date: Sep. 19, 2024

(54) Vacation Club Reservation System with Long Term Leases, Right of Use for Owner, and Automatic Creation of Owner Days

(71) Applicant: Timothy Robert Bratton, Mill Valley, CA (US)

(72) Inventor: Timothy Robert Bratton, Mill Valley, CA (US)

(21) Appl. No.: 18/421,274

(22) Filed: Jan. 24, 2024

Related U.S. Application Data
(60) Provisional application No. 63/481,378, filed on Jan. 24, 2023.

(51) Int. Cl. G06Q 30/0645; G06Q 10/02

(52) U.S. Cl. CPC G06Q 30/0645; G06Q 10/02

(57) ABSTRACT

Embodiments of the present disclosure may include vacation Club Reservation System with Long Term Leases, Right of Use for Owner, and Automatic Creation of Owner Days. In some embodiments, the entity who controls the property signs a long term lease with a vacation club, giving the vacation club the rights to let their vacation club members to reserve and use the property according to predefined rules of use. A reservation system may be provided to the club members so that they can reserve the properties that may be controlled by the club. The owner can reserve some days for personal use (ROD) and based upon certain trigger criteria the vacation club and create forced owner days (FOD). The lease payment can be reduced by the amount of ROD and FOD taken each month.

### BRIEF SUMMARY

Embodiments of the present disclosure may include vacation Club Reservation System with Long Term Leases, Right of Use for Owner, and Automatic Creation of Owner Days. In some embodiments, the entity who controls the property (could be an owner or a lessor, but for this purpose we will call them an owner) signs a long term lease with a vacation club, giving the vacation club the rights to let their vacation club members to reserve and use the property according to predefined rules of use. Typical rules of use include a limit on the number of overnight guests, limit on the number of vehicles on the property, limits on parties and noise, and no open fires allowed. A reservation system may be provided to the club members so that they can reserve the properties that may be controlled by the club.

Embodiments may also include a long term lease may be 30 days or more and this avoids the short term rental rules and restrictions placed by cites, counties, states or other governing authorities. Embodiments may also include when the owner signs the long term lease they retain some rights of use. This may be typically called a “right of use” (ROU) or “right of occupancy” long term lease agreement. It allows the owner of a long-term rental property to use the property themselves while still allowing the leaseholder to continue renting the property. It may be often found in situations where the owner wants to use the property for vacation or personal use, but still wants to generate rental income from it. In the present invention, the vacation club (lessee) may be granted credits back for days that the owner uses the property (owner days) during the term of the lease. During “owner days” the owner may be doing work on the property or may merely be staying at the property. The vacation club provides a scheduling system where the owner may set reserve owner days in advance. Credits for the owner days may be provided to the lessee at a predetermined daily rate, which can vary depending on various factors including seasonal demand, day of the week, and other factors. For instance Friday and Saturday nights would be worth more than midweek nights. Holidays would be worth more than non holiday periods, and high season nights would be worth more than low season nights.

In some embodiments, the reservation system may be a computer system that allows vacation club members to reserve stays at vacation club controlled properties. The vacation club controlled properties may be leased from owners through ROU leases. Embodiments may also include automatic creation of owner days. The reservation system can automatically create owner days if there may be no club members who have reserved the property. The owner days may be created according to pre-determined time thresholds. In one embodiment the system will automatically create an owner day 6 hours before midnight (6 pm) on the day before the owner day may be to be created. In another embodiment, the system could create an owner day 24 hours before the day the owner day may be to be created. This pre-determined amount of time may be called the trigger threshold. Once the trigger threshold may be reached, the owner day may be created and the lessor receives the credit back against their lease. Automatically created owner days can be thought of as forced owner days (FOD) and can be credited back to the lessor at a different rate than the owner days that may be reserved in advance by the owner (ROD-reserved owner days).

Embodiments may also include it should be appreciated that the vacation club could be any sort of asset club where members can reserve the assets. The assets could be houses, apartments, condos, boats, cars, motorcycles, golf carts, RVs, or other types of assets. Embodiments may also include a vacation club reservation system including a vacation club having a long-term lease on a property where the lessor retains rights of use to create reserved owner days (ROD) on the reservation system where RODs may be credited back to the vacation club at a predetermined rate to reduce the rent due from the vacation club to the owner, a system configured to automatically force the creation an owner day (FOD) if no club members have reserved the property 24 hours in advance of that day, the FOD being credited back to the vacation club as a reduction in the rent owed on the lease.

In some embodiments, the claim of claim 1 further including ROD credits that may be credited back may be credited back at a different rate than the FOD credits. In some embodiments, the claim of claim 1 further including different credit rates based on factors selected from day of week, seasonal demand, and holidays.

### BRIEF DESCRIPTION OF THE FIGURES

FIG. 1 is a block diagram illustrating vacation Club Reservation System, according to some embodiments of the present disclosure.

### DETAILED DESCRIPTION

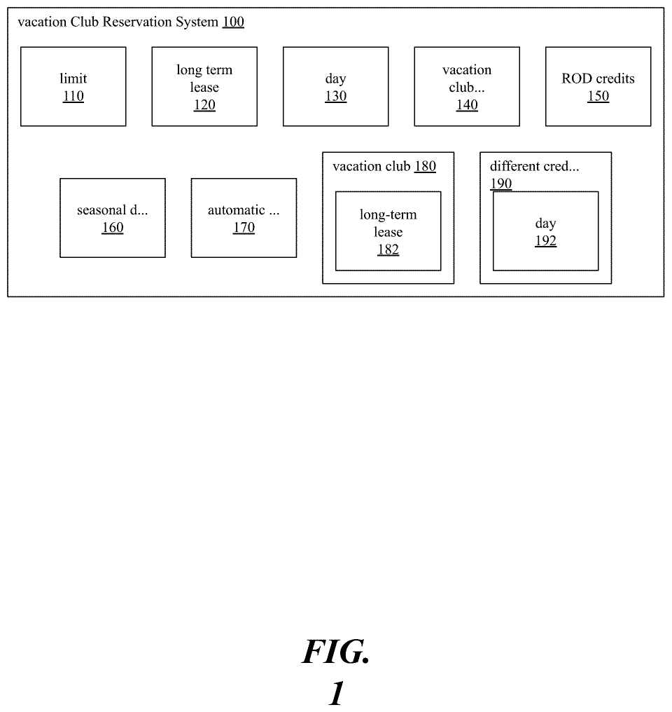

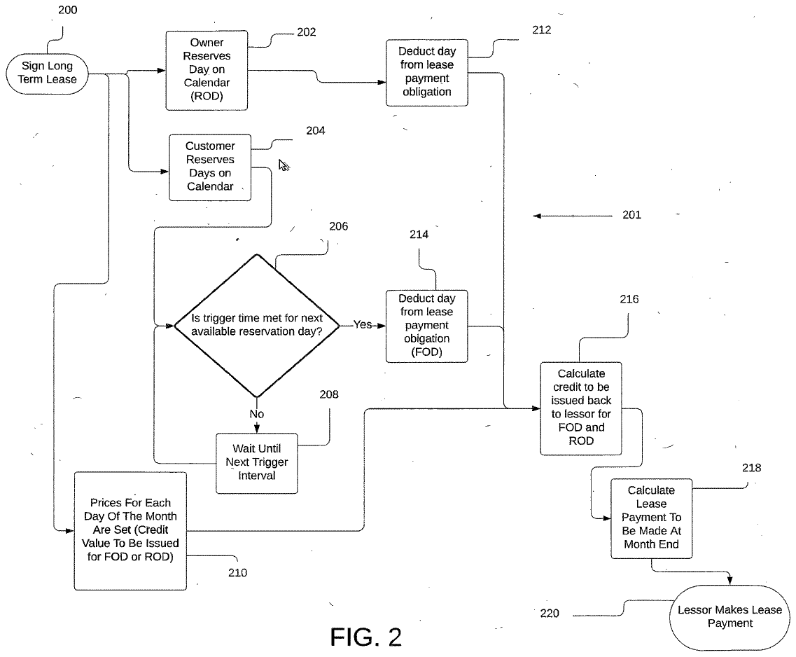

FIG. 1 is a block diagram that describes vacation Club Reservation System 100, according to some embodiments of the present disclosure. In some embodiments, the vacation Club Reservation System 100 may include seasonal demand 160, automatic creation 170 of owner days. The reservation system can automatically create owner days if there may be no club members who, a vacation club reservation system 140, a vacation club 180, ROD credits 150 that may be credited back may be credited back at a different rate than the FOD credits, and different credit rates 190 based on factors selected from:

In some embodiments, the vacation Club Reservation System 100 may also include a limit 110 on the number of overnight guests, limit on the number of vehicles on the property, limits on parties and noise, and no open fires allowed. A reservation system may be provided to the club members so that they can reserve the properties that may be controlled by the club. The vacation Club Reservation System 100 may also include a long term lease 120 may be 30 days or more and this avoids the short term rental rules and restrictions placed by cites, counties, states or other governing authorities. The vacation Club Reservation System 100 may also include day 130 of the week, and other factors. For instance Friday and Saturday nights would be worth more than midweek nights. Holidays would be worth more than non holiday periods, and high season nights would be worth more than low season nights.

In some embodiments, the entity who controls the property (could be an owner or a lessor, but for this purpose we will call them an owner) signs a long term lease with a vacation club, giving the vacation club the rights to let their vacation club members to reserve and use) the property according to predefined rules of use. Typical rules of use. When the owner may sign the long term lease 120 they retain some rights of use. This may be typically called a “right of use” (ROU) or “right of occupancy” long term lease agreement. It allows the owner of a long-term rental property to use the property themselves while still allowing the leaseholder to continue renting the property. It may be often found in situations where the owner may want to use the property for vacation or personal use, but still wants to generate rental income from it. In the present invention, the vacation club (lessee) may be granted credits back for days that the owner uses the property (owner days) during the term of the lease 120. During “owner days” the owner may be doing work on the property or may merely be staying at the property. The vacation club provides a scheduling system where the owner may set reserve owner days in advance. Credits for the owner days may be provided to the lessee at a predetermined daily rate, which can vary depending on various factors.

In some embodiments, the reservation system may be a computer system that allows vacation club members to reserve stays at vacation club controlled properties. The vacation club controlled properties may be leased from owners through ROU leases. Reserved the property. The owner days may be created according to pre-determined time thresholds. In one embodiment the system will automatically create an owner day 6 hours before midnight (6 pm) on the day 130 before the owner day may be to be created. In another embodiment, the system could create an owner day 24 hours before the day 130 the owner day may be to be created. This pre-determined amount of time may be called the trigger threshold. Once the trigger threshold may be reached, the owner day may be created and the lessor receives the credit back against their lease. Automatically created owner days can be thought of as forced owner days (FOD) and can be credited back to the lessor at a different rate than the owner days that may be reserved in advance by the owner (ROD-reserved owner days).

In some embodiments, it should be appreciated that the vacation club could be any sort of asset club where members can reserve the assets. The assets could be houses, apartments, condos, boats, cars, motorcycles, golf carts, RVs, or other types of assets. The vacation club 180 may also include a long-term lease 182 on a property where the lessor retains rights of use to create reserved owner days (ROD) on the reservation system where RODs may be credited back to the vacation club 180 at a predetermined rate to reduce the rent due from the vacation club 180 to the owner, a system configured to automatically force the creation 170 an owner day (FOD) if no club members. Reserved the property 24 hours in advance of that day, the FOD being credited back to the vacation club 180 as a reduction in the rent owed on the lease. The claim of claim 1. The claim of claim 1. The different credit rates 190 may also include day 192 of week, seasonal demand, and holidays.

FIG. 2 illustrates the flow chart 201 that describes the process of calculating the credits on the lease payment. In step 200 a long term lease is signed between the lessor (owner or controller of the asset) and the lessee (the vacation rental club). In step 202 the owner reserves days that they would like to use the asset. In step 204 customers (members of the vacation club) reserve days to use the asset on the calendar. In step 206 the system tests to see if the trigger condition has been met. If it hasn't been met, then the system moves to step 208 where it will wait until the next trigger interval. In step 210 prices for each day of the month are set. These can be set by the owner or the vacation club, or can be predetermined values. In 212 the reserved owner days are deducted from the lease payment obligation. If the condition in step 206 is “yes” the system proceeds to step 214 where the system will deduct the day from the lease obligation (FOD). In 216 the FODs (step 212) and RODs (step 214) are used along with prices set for each day (step 210) to calculate the credit to be issued back to lessor for that month. In step 218 the credits are subtracted from the monthly lease obligation. In step 220 the lessee makes the lease payment to the lessor.

1. A vacation club reservation system comprising:
a vacation club having a long-term lease on a property where the lessor retains rights of use to create reserved owner days (ROD) on the reservation system where RODs are credited back to the vacation club at a predetermined rate to reduce the rent due from the vacation club to the owner, a system configured to automatically force the creation an owner day (FOD) if no club members have reserved the property 24 hours in advance of that day, the FOD being credited back to the vacation club as a reduction in the rent owed on the lease.

2. The claim of claim 1 further comprising ROD credits that are credited back are credited back at a different rate than the FOD credits.

3. The claim of claim 1 further comprising different credit rates based on factors selected from: day of week, seasonal demand, and holidays.
